(19) United States
(12) Patent Application Publication
(10) Pub. No.: US 2018/0025125 A1
(43) Pub. Date: Jan. 25, 2018

(54) EHEALTH AND INTERVENTION PLATFORM

(71) Applicant: Arizona Board of Regents on Behalf of University of Arizona, Tucson, AZ (US)

(72) Inventors: Tracy E. Crane, Tucson, AZ (US); David Parizek, JR., Tucson, AZ (US); Nicholas Eddy, Tucson, AZ (US); George H. Franks, Tucson, AZ (US); Angela Kay Yung, Tucson, AZ (US); Nirav Merchant, Tucson, AZ (US); Colin Scott-Fleming, Tucson, AZ (US); Michelle Yung, Tucson, AZ (US)

(21) Appl. No.: 15/655,553

(22) Filed: Jul. 20, 2017

Related U.S. Application Data
(60) Provisional application No. 62/364,592, filed on Jul. 20, 2016.

(51) Int. Cl. G06F 19/00; G06F 17/30

(52) U.S. Cl. CPC G06F 19/3431; G06F 17/30489; G06F 19/322; G06F 19/363; G06F 19/3443; G06F 17/30705

(57) ABSTRACT

Systems and methods for data aggregation and analytics are disclosed. The systems query a participant for one or more behavioral and/or physical characteristics, receive data, and aggregate it into a participant profile. The disclosed systems and methods calculate the participant's performance based on said data and outputs the results of said calculation to one or more networked computers and/or one or more peripheral devices, associated with the participant or one or more individuals in charge of a study. The disclosed systems and methods are also capable of analyzing the participant data against historical data to identify correlations between the participant's data and adverse future health outcomes in real-time and clustering participants based on their behavioral and/or physical characteristics.

### CROSS-REFERENCE TO RELATED APPLICATION

This application claims priority under 35 U.S.C. §119(e) to U.S. provisional patent application 62/364,592 filed on Jun. 20, 2016, which is hereby incorporated herein by reference in its entirety.

### FIELD OF THE INVENTION

The present invention relates to systems and methods for conducting mobile device-based interventions and behavioral research. The systems and methods of the present invention may be used to deliver theory-based behavior interventions and manage scientific research studies through the use of networked peripheral devices. The systems and methods include features like SMS text messaging, VoIP (for video and voice calls), and automated scheduling. These features facilitate structured communication between researchers and study participants or healthcare professionals and relevant populations.

### BACKGROUND OF THE INVENTION

Management of research data sets is a complex endeavor that becomes exponentially more difficult as sample size increases and as additional variables must be tabulated. In the case of studies involving data that must be collected on a constant basis, there is increased pressure to ensure that participant (e.g. patient) data is collected in a rigorous, timely manner and relayed to individuals in charge of the study (e.g. physicians) promptly. While there are basic data aggregation technologies in existence, there are none that combine data aggregation with HIPAA compliance and analytics that allow for participants to input data and physicians to review an analyzed version of that data in real-time as the study is progressing.

Consequently, there is a need for systems and methods that deliver theory-based behavior interventions and manage scientific research studies through the use of networked peripheral devices.

### SUMMARY OF THE INVENTION

It is therefore an object of the exemplary embodiments disclosed herein to alleviate the disadvantages in the art and provide a data management system that uses networked peripheral devices to aggregate scientific data, quantifies various behavioral and physical characteristics, and identifies behavioral patterns in a participant set.

It is another object of the invention to have a data management system that calculates correlations between behavioral and physical characteristics and participant performance in the scientific study.

It is yet another object of the invention to have a data management system that provides real-time quantification of participant behavior, both in relation to the current study set and to historical participant performance.

### BRIEF DESCRIPTION OF THE FIGURES

A more complete appreciation of the invention and many of the attendant advantages thereof will be readily obtained as the same becomes better understood by reference to the following detailed description when considered in connection with the accompanying drawings, wherein:

FIG. 1 is an exemplary embodiment of the eHIP data aggregation and analysis system; and

FIG. 2 is an exemplary logic flow diagram demonstrating how the system incorporates and analyzes scientific data.

### DETAILED DESCRIPTION OF PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose. Several preferred embodiments of the invention are described for illustrative purposes, it being understood that the invention may be embodied in other forms not specifically shown in the drawings.

Mobile Health (“mHealth”) is the practice of public health and medicine supported by web and mobile devices. Systems that implement mHealth protocols allow for a more streamlined implementation of scientific study and improve the ability of researchers to track data trends. Inventors at the University of Arizona have developed a software platform called eHIP (“eHealth & Intervention Platform”). eHIP is an adaptable “software as a service” platform that provides researchers and healthcare professionals a framework for building web and mobile device-oriented research projects or interventions. It includes communication features (including text, voice, and video messaging systems), data collection, and web-based forms. Features can be modified (or built from scratch) to suit the specific needs of any project.

eHIP is the product of the University of Arizona Bio Computing Facility. Its development was prompted by the organization's collaborations with entities in the public health, nutrition, psychiatry, nursing, pharmacy, and medical fields. The eHIP platform can be used in public health, by healthcare providers, in research, and in other data-oriented projects that will be readily apparent to one of ordinary skill in the art. The eHIP platform has been adapted and used successfully to build a variety of projects, including Stealth Health (text messages delivered to youth in order to promote physical activity and healthier diets), eLEAS (online psychiatric testing), and Walk Across Arizona (fitness promotion program where participants log exercise data online). The eHIP platform includes features like SMS text messaging, VoIP (for video and voice calls), and automated scheduling. These features facilitate structured communication between researchers and study participants or healthcare professionals and relevant populations.

eHIP is a software platform optimized for delivering theory-based behavior interventions and managing scientific research studies that utilize mHealth and/or eHealth. This broad and adaptable solution leverages affordable technologies (e.g. cloud based telephony) to engage and retain study subjects in interventions while providing real-time data to investigators. It is currently being used in numerous multipurpose, web- and mobile-based applications to promote a variety of lifestyle behavior changes (smoking cessation, diet and physical activity) in both national, multi-site studies.

In the sphere of public health, one particular example is the “Healthy is Happy” program, which delivered health-oriented text messages to youths in at-risk populations. Delivering interventions over the Internet using the eHIP platform leads to substantial savings versus in-person delivery. For healthcare providers, the eHIP platform may be used in eLEAS, in which psychiatric testing results and data are delivered electronically. eHIP includes security features that make it HIPAA-compliant, an advantage over prior technologies. Migration of services to an easy-to-use secure online platform embodied by the eHIP platform make healthcare delivery more efficient for practitioners by providing real-time access to patient data and patient performance.

An example of eHIP's utility in research is the Recaller Project. The eHIP platform allows subjects to upload photos of their meals to researchers via a mobile interface so their dietary intake could be analyzed. Studies that would otherwise be impossible without mobile technology (real-time monitoring of heart rate over long periods of time, for example) or projects that would otherwise require a huge time investment on the behalf of the subjects or researcher (meticulous records kept of caloric intake) become much more achievable by using the eHIP platform. Thus, in general, the eHIP platform makes it possible to collect seemingly any type of data, have it analyzed, and also provide communications. Any data-driven project—regardless of whether it is strictly research, healthcare, or public health-related—may be powered by the eHIP platform. Exemplarily, the eHIP platform could be used in conservation interventions: water usage data could be collected from individuals and analyzed. Individuals who use large amounts of water could then be targeted to receive tips on reducing water usage or provided low-flow shower heads.

The eHIP platform represents an innovative, flexible, and scalable solution for the deployment and case management of large research and intervention projects including those involving cancer, tobacco cessation, obesity, diabetes, alcoholism, drug abuse, stress management, immunization, sun safety, oral hygiene, medicine adherence, diet, physical activity, really anywhere that behavior modification is sought.

The eHIP application suite integrates a comprehensive spectrum of web-based technologies including, but not limited to, IP telephony, SMS, MMS, forums, social networking, and email, as well as wearable devices and sensors (e.g. FitBits) for the delivery and collection of health information targeting an increasingly technologically adept subject population. The software tracks all technology “touches” in real-time to include phone calls, text messages, and emails as well as all participation activity of study participants. This allows for immediate evaluation of data quality, as well as personalized feedback to study participants for tailored and specific behavior change for each individual subject. Further, the system allows for the deployment of a standardized protocol using cost-effective and HIPAA-compliant software to the target population regardless of geographic location.

The eHIP platform therefore has a number of advantages over other technologies. For example, the eHIP platform has already been successfully used to develop research and intervention tools that involve the web or mobile devices, including numerous national and multi-site studies. The platform can also encompass the entirety of the online functionality required by a given project, from consulting and software development to deployment, data analysis, and archival. Moreover, the eHIP platform is modular in nature. It can include many features—data collection, data analysis, intervention delivery—or only a few. Additionally, the data gathered from relevant populations by components of the eHIP platform can be made immediately available for use.

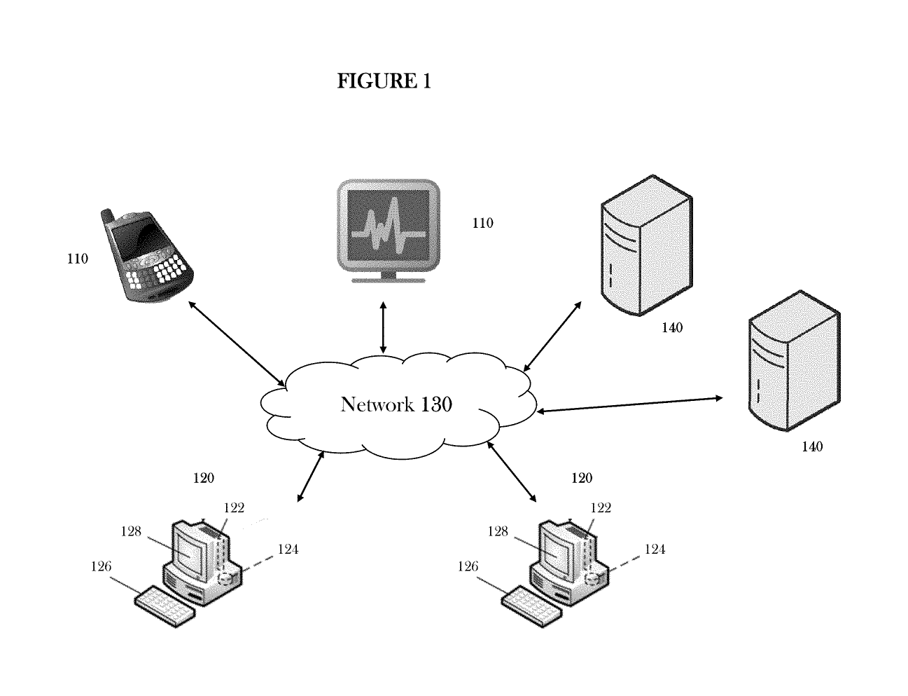

FIG. 1 is an exemplary embodiment of the data aggregation and analytics system. In the exemplary system 100, one or more peripheral devices 110 are connected to one or more computers 120 through a network 130. Examples of peripheral devices 110 include smartphones, tablets, wearable devices such as smartwatches, medical devices such as EKGs and blood pressure monitors, and any other devices that collect patient data that are known in the art. The network 130 may be a wide-area network, like the Internet, or a local area network, like an intranet. Because of the network 130, the physical location of the peripheral devices 110 and the computers 120 has no effect on the functionality of the hardware and software of the invention. Both implementations are described herein, and unless specified, it is contemplated that the peripheral devices 110 and the computers 120 may be in the same or in different physical locations. Communication between the hardware of the system may be accomplished in numerous known ways, for example using network connectivity components such as a modem or Ethernet adapter. The peripheral devices 110 and the computers 120 will both include or be attached to communication equipment. Communications are contemplated as occurring through industry-standard protocols such as HTTP.

Each computer 120 is comprised of a central processing unit 122, a storage medium 124, a user-input device 126, and a display 128. Examples of computers that may be used are: commercially available personal computers, open source computing devices (e.g. Raspberry Pi), commercially available servers, and commercially available portable device (e.g. smartphones, smartwatches, tablets). In one embodiment, each of the peripheral devices 110 and each of the computers 120 of the system have eHIP software related to the system installed on it. In such an embodiment, data related to the patient studies performed are stored locally on the networked computers 120 or alternately, on one or more remote servers 140 that are accessible to any of the networked computers 120 through a network 130. In alternate embodiments, the eHIP software runs as an application on the peripheral devices 110.

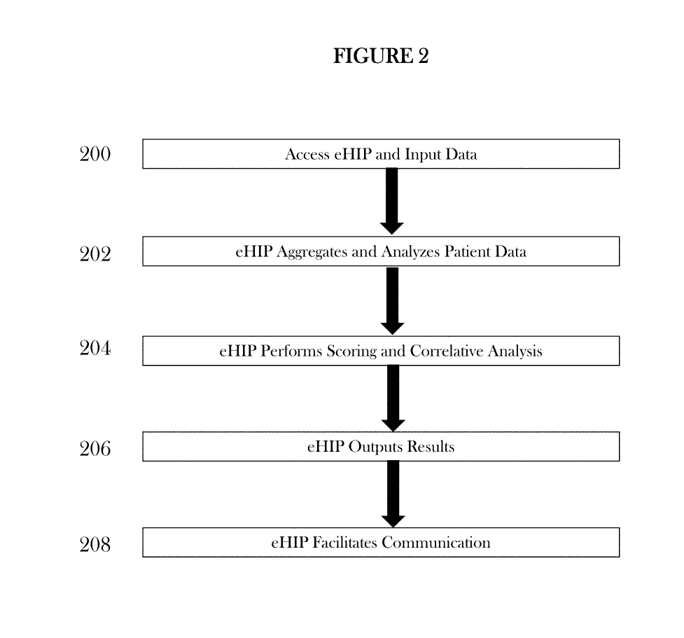

FIG. 2 is an exemplary logic flow diagram of the software processes performed using the hardware described in FIG. 1 above. The process begins with step 200, “Access eHIP and Input Data,” where the patient accesses the eHIP software on his or her peripheral device 110 and inputs responses to behavioral and/or physical characteristics. Behavioral characteristics may include such traits as daily caloric intake, types of food ingested, mental health, drug dosages, locations visited, environment, and others that will be readily apparent to those of ordinary skill in the art. Physical characteristics may include such traits as age, height, weight, blood pressure, cholesterol, glucose concentration, or others that will be readily apparent to one of ordinary skill in the art.

Behavioral and physical characteristics requiring a response from the patient may be set in advance of a study or added ad-hoc at any time. At step 202, “eHIP Aggregates and Analyzes Patient Data,” the patient's responses are uploaded to any of the networked computers 120 or the one or more remote servers 140. At the networked computers 120 or the one or more remote servers 140, the eHIP software aggregates the patient's data into a searchable profile and analyzes the patient's behavioral and physical characteristics against other patients in the study. At step 204, “eHIP Performs Scoring and Correlative Analysis,” the eHIP software scores the patient relative to other patients in the study based on each of the behavioral and physical characteristics monitored, as well as creating a composite score of the patient's overall performance. In alternative embodiments, the eHIP software may also apply correlative calculations against historical patient data to determine whether changes in certain behavioral and/or physical characteristics result in a statistically significant change to future health outcomes. The eHIP software may also cluster participants based on behavioral and/or physical characteristics to identify trends related to environment, location, etc.

At step 206, “eHIP Outputs Results,” the eHIP software at the networked computers 120 or the one or more remote servers 140 outputs the results of its calculations to the networked computers 120 and/or the peripheral devices 110. From the networked computers 120 and/or the peripheral devices 110, a patient or physician can obtain a real-time quantification of the patient's behavior and physical performance, while providing recommendations for improvements to the patient's future performance and identifying potential warning signs in behavioral and/or physical characteristics (or in their composite score) signaling adverse future health outcomes. Based on the calculations, at step 208, “eHIP Facilitates Communication,” the eHIP software can be used to facilitate SMS text messaging between patients and physicians, VoIP (“Voice over Internet Protocol”) for video and voice calls, and automated scheduling for appointments to discuss participant performance.

The foregoing description and drawings should be considered as illustrative only of the principles of the invention. The invention is not intended to be limited by the preferred embodiment and may be implemented in a variety of ways that will be clear to one of ordinary skill in the art. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A system for data aggregation and analytics comprised of one or more peripheral devices, a network, one or more networked computers, and one or more remote servers, wherein the system queries a participant for one or more behavioral and/or physical characteristics, receives data from the participant, aggregates said data into a searchable participant profile, calculates the participant's performance based on said data, and outputs the results of said calculation to one or more networked computers and/or one or more peripheral devices, associated with the participant or one or more individuals in charge of a study, wherein said results quantify the participant's behavior and physical performance and determine improvements to the participant's future performance.

2. The system of claim 1, wherein the system further analyzes the participant data against historical data to identify correlations between the participant's data and adverse future health outcomes.

3. The system of claim 1, wherein the system clusters participants based on behavioral and/or physical characteristics.

4. The system of claim 1, wherein the participant's performance is calculated in real-time.

5. The system of claim 1, wherein the system is further able to facilitate communication between a participant and one or more individuals in charge of a study, using SMS text messaging, using VoIP, and providing automated scheduling for appointments to discuss participant performance.

6. A method for data aggregation and analytics comprising the steps of:
querying a participant for one or more behavioral and/or physical characteristics;
receiving data from the participant;
aggregating said data into a participant profile;
calculating the participant's performance based on said data; and
outputting the results of said calculation to one or more networked computers and/or one or more peripheral devices, associated with the participant or one or more individuals in charge of a study, wherein said results quantify the participant's behavior and physical performance and determine improvements to the participant's future performance.

7. The method of claim 6, further comprising the step of analyzing the participant data against historical data to identify correlations between the participant's data and adverse future health outcomes.

8. The method of claim 6, further comprising the step of clustering participants based on behavioral and/or physical characteristics.

9. The method of claim 6, further comprising the step of calculating the participant's performance in real-time.

10. The method of claim 6, further comprising the step facilitating communication between a participant and one or more individuals in charge of a study, using SMS text messaging, using VoIP, and proving automated scheduling for appointments to discuss participant performance.
